(19) United States
(12) Patent Application Publication
(10) Pub. No.: US 2026/0179967 A1
(43) Pub. Date: Jun. 25, 2026

(54) METHOD FOR MANUFACTURING BATTERY AND BATTERY

(71) Applicants: TOYOTA JIDOSHA KABUSHIKI KAISHA, Toyota-shi (JP); KANSAI PAINT CO., LTD., Amagasaki-shi (JP)

(72) Inventors: Masatsugu KAWAKAMI, Sunto-gun (JP); Hideaki NISHIMURA, Sunto-gun (JP); Tetsuya WASEDA, Toyota-shi (JP); Rikuya SUZUKI, Hiratsuka-shi (JP); Takahiro YAZAKI, Hiratsuka-shi (JP); Masakazu TAMARU, Hiratsuka-shi (JP)

(73) Assignees: TOYOTA JIDOSHA KABUSHIKI KAISHA, Toyota-shi (JP); KANSAI PAINT CO., LTD., Amagasaki-shi (JP)

(21) Appl. No.: 19/379,910

(22) Filed: Nov. 5, 2025

(30) Foreign Application Priority Data
Dec. 20, 2024 (JP) 2024-225756

(51) Int. Cl. H01M 4/66; H01M 4/04

(52) U.S. Cl. CPC H01M 4/668; H01M 4/0404

(57) ABSTRACT

A method for manufacturing a battery includes: a step of obtaining a resin current collector by applying a first slurry containing a first resin and a second resin to one or both surfaces of a substrate and solidifying the first slurry to form a resin layer; and a step of obtaining an electrode by applying a second slurry containing an electrode active material and a solvent to the resin layer of the resin current collector and solidifying the second slurry to form an electrode active material layer. The first resin is a resin that is not soluble in the solvent of the second slurry. The second resin is a resin that is soluble in the solvent of the second slurry.

### CROSS-REFERENCE TO RELATED APPLICATION

This application claims priority to Japanese Patent Application No. 2024-225756 filed on Dec. 20, 2024. The disclosure of the above-identified application, including the specification, drawings, and claims, is incorporated by reference herein in its entirety.

### BACKGROUND

### 1. Technical Field

The present disclosure relates to methods for manufacturing a battery and batteries.

### 2. Description of Related Art

In order to reduce the weight of batteries, resin current collectors have been developed. For example, Japanese Unexamined Patent Application Publication No. 2024-037018 (JP 2024-037018 A) discloses a resin current collector including an electrically conductive resin layer in which an electrically conductive filler is dispersed in a resin, and a fluororesin layer laminated on the electrically conductive resin layer.

### SUMMARY

In order to further enhance battery safety, it is desired to improve the adhesion between a resin current collector and an electrode active material layer.

The present disclosure has been made in view of the above circumstances. It is an object of the present disclosure to provide a method for manufacturing a battery and a battery that exhibit excellent adhesion between a resin current collector and an electrode active material layer.

Specific means for addressing the above issue includes the following aspects.
(1) A method for manufacturing a battery, the method including:
a step of obtaining a resin current collector by applying a first slurry containing a first resin and a second resin to one or both surfaces of a substrate and solidifying the first slurry to form a resin layer; and
a step of obtaining an electrode by applying a second slurry containing an electrode active material and a solvent to the resin layer of the resin current collector and solidifying the second slurry to form an electrode active material layer, wherein:
the first resin is a resin that is not soluble in the solvent of the second slurry; and the second resin is a resin that is soluble in the solvent of the second slurry.
(2) The method according to (1), wherein
the mass ratio of the first resin to the total of the first resin and the second resin contained in the first slurry is from 10 mass % to 85 mass %.
(3) A battery including:
an electrode including a resin current collector that includes a substrate and a resin layer disposed on one or both surfaces of the substrate, and an electrode active material layer that is in contact with the resin layer of the resin current collector, wherein:
the resin layer of the resin current collector contains a first resin and a second resin;
the first resin is a resin that does not exhibit solubility in a solvent species of a residual solvent in the electrode active material layer; and
the second resin is a resin that exhibits solubility in the solvent species of the residual solvent in the electrode active material layer.
(4) A battery including:
an electrode including a resin current collector that includes a substrate and a resin layer disposed on one or both surfaces of the substrate, and an electrode active material layer that is in contact with the resin layer of the resin current collector, wherein:
the resin layer of the resin current collector contains an electrically conductive material;
the electrode active material layer contains a binder resin; and
a region in which the electrically conductive material of the resin layer and the binder resin of the electrode active material layer are intermixed is present at an interface between the resin layer and the electrode active material layer.
(5) The battery according to (3) or (4), wherein the battery is a solid-state battery.

The present disclosure provides a method for manufacturing a battery and a battery that exhibit excellent adhesion between a resin current collector and an electrode active material layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial sectional view illustrating an example of a layer structure of a solid-state battery;

FIG. 2 is a graph showing an example of a component profile of an anode cross-section based on Raman spectroscopy analysis; and

FIG. 3 is a graph showing another example of a component profile of an anode cross-section based on Raman spectroscopy analysis.

### DETAILED DESCRIPTION OF EMBODIMENTS

Hereinafter, embodiments of the present disclosure will be described. The following descriptions and examples are intended to illustrate the embodiments and are not intended to limit the scope of the embodiments.

In the present disclosure, when an embodiment is described with reference to the drawings, the configuration of the embodiment is not limited to the configuration illustrated in the drawings. The sizes of the members shown in the drawings are conceptual, and the relative sizes between the members are not limited thereto.

In the present disclosure, the term “step” refers not only to an independent step but also includes a step that may not be clearly distinguishable from another step, as long as the intended purpose of the step is achieved.

In the present disclosure, the expression “A and/or B” has the same meaning as “at least one of A and B.” That is, “A and/or B” means A alone, B alone, or a combination of A and B.

In the present disclosure, numerical ranges indicated using “to” represent ranges inclusive of minimum and maximum values specified before and after “to”, respectively.

In numerical ranges described in stages in the present disclosure, the upper or lower limit of one numerical range may be replaced with the upper or lower limit of another numerical range. In addition, in numerical ranges described in the present disclosure, the upper or lower limit of a numerical range may be replaced with a value disclosed in the examples.

In the present disclosure, when referring to the amount of each component in a composition, the amount refers to the total amount of all substances corresponding to the component that are present in the composition, unless otherwise specified, when multiple types of such substances are present.

### Method for Manufacturing Battery

A method for manufacturing a battery according to the present disclosure includes:
a step of obtaining a resin current collector by applying a first slurry containing a first resin and a second resin to one or both surfaces of a substrate and solidifying the first slurry to form a resin layer;
a step of obtaining an electrode by applying a second slurry containing an electrode active material and a solvent to the resin layer of the resin current collector and solidifying the second slurry to form an electrode active material layer.

The first resin is a resin that is not soluble in the solvent of the second slurry, and

The second resin is a resin that is soluble in the solvent of the second slurry.

In the method for manufacturing a battery according to the present disclosure, either or both of an anode and a cathode are manufactured by the above steps. A battery manufactured by the method of the present disclosure exhibits excellent adhesion between the resin current collector and the electrode active material layer. The mechanism is presumed to be as follows.

The resin layer of the resin current collector is a layer formed using the first slurry containing the first resin and the second resin. Therefore, the resin layer of the resin current collector contains both the first resin and the second resin. When the second slurry is applied to the resin layer of the resin current collector, the first resin that is not soluble in the solvent of the second slurry serves to maintain the shape of the resin layer. On the other hand, the second resin that is soluble in the solvent of the second slurry enhances the wettability of the second slurry with respect to the resin layer. As a result, it is presumed that the electrode active material layer formed by solidifying the second slurry adheres well to the resin layer.

A battery manufactured by the method of the present disclosure exhibits excellent adhesion between the resin current collector and the electrode active material layer. Accordingly, cracking is less likely to occur in the electrode, and the internal resistance of the battery can be kept low.

In the present disclosure, a resin that is soluble in a solvent is referred to as “soluble resin,” and a resin that is not soluble in a solvent is referred to as “insoluble resin.” Whether a resin is a “soluble resin” or an “insoluble resin” is determined by the following method.

First, 0.025 g of the resin is added to 10 mL of a solvent at a temperature of 27.5° C.±2.5° C., and the resultant mixture is stirred gently for 30 minutes using a magnetic stir bar and a magnetic stirrer. After stirring, the resin is visually observed. When the resin is in a dissolved state (i.e., not in a state of separation (including sedimentation and floating), colloid, emulsion, or suspension), it is determined to be a “soluble resin.” When the resin remains (i.e., is in a state of separation (including sedimentation and floating), colloid, emulsion, or suspension), it is determined to be an “insoluble resin.”

The components of the method for manufacturing a battery according to the present disclosure will now be described in detail.

### First Slurry and Resin Layer

The first slurry is prepared by dissolving or dispersing the first resin and the second resin in a solvent. The first resin may be a single resin or a combination of two or more resins. The second resin may be a single resin or a combination of two or more resins.

Examples of the first resin and the second resin include: fluororesins (e.g., polyvinylidene fluoride, polytetrafluoroethylene), vinyl resins (e.g., polyvinyl chloride, polyvinyl 30 acetate, polyvinyl alcohol, polyvinyl butyral, polyvinyl acetal, polyvinylpyrrolidone, acrylic resins), polyolefin resins (e.g., polyethylene, polypropylene, polymethylpentene, polycycloolefin), polyester resins (e.g., polyethylene terephthalate), and various composite resins thereof. Additionally, engineering plastics such as synthetic rubbers (e.g., styrene-butadiene rubber, polyacrylonitrile), epoxy resins, silicone resins, and polyether nitrile may be used as the first resin and the second resin.

The molecular weights of the first resin and the second resin are preferably from 1,000 to 300,000 as weight-average molecular weights, more preferably from 5,000 to 200,000, and even more preferably from 10,000 to 150,000.

It is preferable that the molecular weight of the first resin is greater than that of the second resin.

In the present disclosure, the molecular weight of the resin refers to a value obtained by gel permeation chromatography (GPC), converted based on the molecular weight of standard polystyrene. Specifically, the weight-average molecular weight is calculated by measuring the molecular weight distribution using a GPC system “HLC-8120GPC” (manufactured by Tosoh Corporation) and four columns “TSKgel G-4000HXL,” “TSKgel G-3000HXL,” “TSKgel G-2500HXL,” and “TSKgel G-2000HXL” (all manufactured by Tosoh Corporation), with tetrahydrofuran as the mobile phase, at a measurement temperature of 40° C., a flow rate of 1 mL/min, and using an refractive index (RI) detector.

Vinyl resins are preferably used as the first resin and the second resin, and functional group-containing vinyl resins are particularly preferable. The term “vinyl resin” as used in the present disclosure refers to a resin obtained by polymerizing or copolymerizing a monomer including a monomer containing a polymerizable unsaturated group as represented by formula (1) below. The resulting (co) polymer may be modified after (co) polymerization.

$$C {( — R )}_{2} = {C ( — R )}_{2} \qquad ( 1 )$$

In formula (1), R preferably represents a hydrogen atom or an organic group, and the plurality of R groups in the molecule may be the same or different.

The molecular weight of the vinyl resin is preferably from 1,000 to 300,000 as a calculated molecular weight, more preferably from 5,000 to 200,000, and even more preferably from 10,000 to 150,000. The calculated molecular weight of the vinyl resin is obtained by first calculating the average molecular weight of one unit based on the molecular weights and numbers of organic groups and substituents (e.g., acetal groups, acetyl groups, hydroxyl groups, alkyl groups), and then multiplying the calculated average molecular weight by the average degree of polymerization.

From the viewpoint of improving the dispersibility of the electrically conductive material in the first slurry, vinyl resins (particularly functional group-containing vinyl resins) preferably contain, as a functional group, at least one polar functional group selected from the group consisting of an amide group, an imide group, a hydroxyl group, a carboxy group, a sulfonic acid group, a phosphoric acid group, a silanol group, an amino group, a pyrrolidone group, and a nitrile group, and more preferably contain a hydroxyl group. The functional group concentration in the vinyl resin may be from 0.1 mmol/g to 23 mmol/g, preferably from 0.5 mmol/g to 10 mmol/g, and more preferably from 1.0 mmol/g to 5.0 mmol/g.

From the viewpoint of mutual compatibility, it is preferable that the first resin and the second resin be of the same type. Examples of methods for selectively producing a soluble resin or an insoluble resin include, for example, adjusting the molecular weight, introducing a polar or non-polar group, and introducing a side chain.

The mass ratio of the first resin to the total of the first and second resins contained in the first slurry is preferably from 10 mass % to 85 mass %.

When the mass ratio of the first resin is 10 mass % or more, the shape of the resin layer of the resin current collector tends to be maintained when the second slurry is applied to the resin layer.

When the mass ratio of the first resin is 85 mass % or less, the second slurry tends to adhere more readily to the resin layer of the resin current collector when the second slurry is applied to the resin layer.

The mass ratio of the first resin to the total of the first and second resins contained in the first slurry is more preferably from 15 mass % to 70 mass %, and even more preferably from 20 mass % to 40 mass %.

The volume ratio of the first resin to the total of the first and second resins contained in the first slurry is preferably from 10 vol % to 85 vol %.

When the volume ratio of the first resin is 10 vol % or more, the shape of the resin layer of the resin current collector tends to be maintained when the second slurry is applied to the resin layer.

When the volume ratio of the first resin is 85 vol % or less, the second slurry tends to adhere more readily to the resin layer of the resin current collector when the second slurry is applied to the resin layer.

The volume ratio of the first resin to the total of the first and second resins contained in the first slurry is more preferably from 15 vol % to 70 vol %, and even more preferably from 20 vol % to 40 vol %.

As used herein, the term “volume” refers to the volume in the resin layer after the first slurry has been solidified to form the resin layer.

The solvent for the first slurry may be selected according to the types of the first resin and the second resin. Examples of the solvent for the first slurry include alcohols.

The first slurry may contain components other than the first resin and the second resin. Examples of such other components include an electrically conductive material and a filler.

Examples of the electrically conductive material include carbon materials, electrically conductive polymers, and metal particles.

Examples of carbon materials include particulate carbon materials and fibrous carbon materials. Examples of particulate carbon materials include graphite, acetylene black, and Ketjen black. Examples of fibrous carbon materials include carbon nanotubes, carbon nanofibers, and vapor-grown carbon fibers (VGCF).

Examples of electrically conductive polymers include polythiophene, polyacetylene, poly(p-phenylene), and polyisothianaphthene.

Examples of metal particles include particles of nickel, copper, iron, and stainless steel.

Among the electrically conductive materials, carbon materials are preferable from the viewpoint of adhesion between the resin layer and the electrode active material layer, and from the viewpoint of electronic conductive properties of the resin layer.

The content of the electrically conductive material is preferably from 5 mass % to 50 mass % relative to the total solid content of the resin layer, more preferably 10 mass % to 40 mass %, and even more preferably 15 mass % to 30 mass %.

The substrate to which the first slurry is applied (i.e., the substrate of the resin current collector) is preferably a metal layer. Examples of the metal layer include metal foils such as stainless steel, aluminum, nickel, iron, copper, and titanium.

The thickness of the substrate may be, for example, from 1 μm to 50 μm, from 3 μm to 25 μm, or from 5 μm to 10 μm.

The first slurry is applied to one or both surfaces of the substrate. By solidifying the first slurry on the substrate, a resin layer is formed, whereby a resin current collector is obtained.

The solidification of the first slurry on the substrate is carried out by, for example, heat application that allows removal of the solvent of the first slurry. When the first resin is a thermosetting resin, it is preferable to further apply heat to cure the first resin after the heat application for the purpose of solvent removal.

From the viewpoint of battery energy density, a thinner resin layer is more preferable, whereas from the viewpoint of adhesion to the electrode active material layer, the resin layer is preferably not excessively thin. The thickness of the resin layer is preferably from 0.1 μm to 5 μm, more preferably from 0.5 μm to 4 μm, and even more preferably from 1 μm to 3 μm.

### Second Slurry and Electrode Active Material Layer

The second slurry is prepared by dissolving or dispersing an electrode active material (an anode active material or a cathode active material) in a solvent.

Examples of the solvent for the second slurry include butyl butyrate, diisobutyl ketone, and tetralin.

Examples of the anode active material include lithium (Li)-based active materials such as metallic lithium, carbon-based active materials such as graphite, oxide-based active materials such as lithium titanate, and silicon (Si)-based active materials such as elemental silicon. The anode active material may be a single material or a mixture of two or more materials.

Examples of the cathode active material include lithium transition metal composite oxides. Examples of lithium transition metal composite oxides include LiMn₂O₄, LiMO₂ (M is Ni, Co, or Mn), and LiMPO₄ (M is Fe, Co, Ni, or Mn). The cathode active material may be a single material or a mixture of two or more materials.

The second slurry may further contain at least one of a binder resin, a solid electrolyte, and an electrically conductive material.

Examples of the binder resin include rubber materials such as butadiene rubber (BR), acrylate-butadiene rubber (ABR), styrene-butadiene rubber (SBR), acrylonitrile-butadiene rubber (NBR), and butyl rubber (isobutylene-isoprene rubber), halogenated vinyl resins, and polyolefins.

The solid electrolyte preferably includes one selected from the group consisting of sulfide solid electrolytes, oxide solid electrolytes, and halide solid electrolytes. The sulfide solid electrolyte contains sulfur(S) as a main anionic element, and preferably further contains, for example, lithium (Li) and element A. Element A is at least one element selected from the group consisting of phosphorus (P), arsenic (As), antimony (Sb), silicon (Si), germanium (Ge), tin (Sn), boron (B), aluminum (Al), gallium (Ga), and indium (In). The oxide solid electrolyte contains oxygen (O) as a main anionic element, and preferably further contains, for example, lithium (Li) and element Q. Element Q is at least one element selected from the group consisting of niobium (Nb), boron (B), aluminum (Al), silicon (Si), phosphorus (P), titanium (Ti), zirconium (Zr), molybdenum (Mo), tungsten (W), and sulfur (S).

The halide solid electrolyte is suitably a solid electrolyte containing lithium (Li), M, and X (where M is at least one element selected from titanium (Ti), aluminum (Al), and yttrium (Y), and X is fluorine (F), chlorine (Cl), or bromine (Br)).

Examples of the electrically conductive material include carbon materials, electrically conductive polymers, and metal particles.

Examples of carbon materials include particulate carbon materials and fibrous carbon materials. Examples of particulate carbon materials include graphite, acetylene black, and Ketjen black. Examples of fibrous carbon materials include carbon nanotubes, carbon nanofibers, and vapor-grown carbon fibers (VGCF).

Examples of electrically conductive polymers include polythiophene, polyacetylene, poly(p-phenylene), and polyisothianaphthene.

Examples of metal particles include particles of nickel, copper, iron, and stainless steel.

The second slurry is applied to the resin layer of the resin current collector. By solidifying the second slurry on the resin layer, an electrode active material layer is formed, whereby an electrode is obtained.

The solidification of the second slurry on the resin layer of the resin current collector is carried out by, for example, heat application that allows removal of the solvent of the second slurry. When the binder resin is a thermosetting resin, it is preferable to further apply heat to cure the binder resin after the heat application for the purpose of solvent removal.

The thickness of the electrode active material layer is preferably adjusted within the range of 1 μm to 100 μm in consideration of factors such as battery energy density, charge-discharge characteristics, and reduction in interlayer delamination.

The electrode formed using the first slurry and the second slurry may be either an anode or a cathode, or both.

The method for manufacturing a battery according to the present disclosure preferably further includes, after the step of obtaining an electrode,
a step of producing a battery element suitable for a desired battery shape and application, and
a step of housing the battery element in an exterior case, attaching a cathode tab and an anode tab, and vacuum-sealing the case.

Examples of the battery element include a stacked body in which electrodes and solid electrolytes are alternately stacked, and a stacked body in which electrodes and separators are alternately stacked and impregnated with an electrolyte solution. Examples of the exterior case include an aluminum laminate film pack and a metal can.

### Battery

A battery manufactured by the method according to the present disclosure is embodied in two forms. These forms will be described below as a first battery and a second battery.

The first battery according to the present disclosure includes an electrode including a resin current collector that includes a substrate and a resin layer disposed on one or both surfaces of the substrate, and an electrode active material layer that is in contact with the resin layer of the resin current collector.

The resin layer of the resin current collector contains a first resin and a second resin.

The first resin is a resin that does not exhibit solubility in a solvent species of a residual solvent in the electrode active material layer.

The second resin is a resin that exhibits solubility in the solvent species of the residual solvent in the electrode active material layer.

One or both of an anode and a cathode of the first battery are the electrode described above.

The residual solvent in the electrode active material layer is derived from the slurry used to form the electrode active material layer, that is, the second slurry used in the method for manufacturing a battery according to the present disclosure.

Whether a resin contained in the resin layer of the resin current collector exhibits solubility in the solvent species of the residual solvent in the electrode active material layer is determined as follows.

The resin layer of the resin current collector is first analyzed to identify at least two types of resins. The electrode active material layer is then analyzed to identify the solvent species of the residual solvent.

Using the identified resin types and solvent species, it is determined whether each resin is a “soluble resin” or an “insoluble resin” by the method described above.

The second battery according to the present disclosure includes an electrode including a resin current collector that includes a substrate and a resin layer disposed on one or both surfaces of the substrate, and an electrode active material layer that is in contact with the resin layer of the resin current collector.

The resin layer of the resin current collector contains an electrically conductive material. The electrode active material layer contains a binder resin.

A region in which the electrically conductive material of the resin layer and the binder resin of the electrode active material layer are intermixed is present at the interface between the resin layer of the resin current collector and the electrode active material layer.

One or both of an anode and a cathode of the second battery are the electrode described above.

The second battery of the present disclosure includes the electrode formed using the first slurry containing an electrically conductive material and the second slurry containing a binder resin.

When the second slurry is applied to the resin layer of the resin current collector, at least part of the second resin in the resin layer dissolves in the solvent of the second slurry. At this time, the binder resin in the second slurry infiltrates the resin layer, thereby forming, at the interface between the resin layer and the electrode active material layer, a region in which the electrically conductive material of the resin layer and the binder resin of the electrode active material layer are intermixed.

The region in which the electrically conductive material of the resin layer and the binder resin of the electrode active material layer are intermixed may occupy, for example, ⅕ to ⅘ of the thickness of the resin layer.

The presence of the region in which the electrically conductive material of the resin layer and the binder resin of the electrode active material layer are intermixed can be confirmed by performing Raman spectroscopy on a cross section of the electrode and generating a component profile in the thickness direction. An example of Raman spectroscopy is presented in Example 6 described below.

The battery according to the present disclosure includes both solid-state batteries and liquid batteries.

The method for manufacturing a battery according to the present disclosure and the battery according to the present disclosure are particularly suitable for solid-state batteries.

The solid-state battery of the present disclosure includes so-called all-solid-state batteries using a solid electrolyte as the electrolyte. In the solid-state battery of the present disclosure, the solid electrolyte may contain less than 10 mass % of an electrolyte solution relative to the total mass of the electrolyte, and may be a composite solid electrolyte containing both an inorganic solid electrolyte and a polymer electrolyte.

The shape and application of the solid-state battery of the present disclosure are not limited. For example, the solid-state battery of the present disclosure may be applied to hybrid electric vehicles (HEVs), plug-in hybrid electric vehicles (PHEVs), and battery electric vehicles (BEVs).

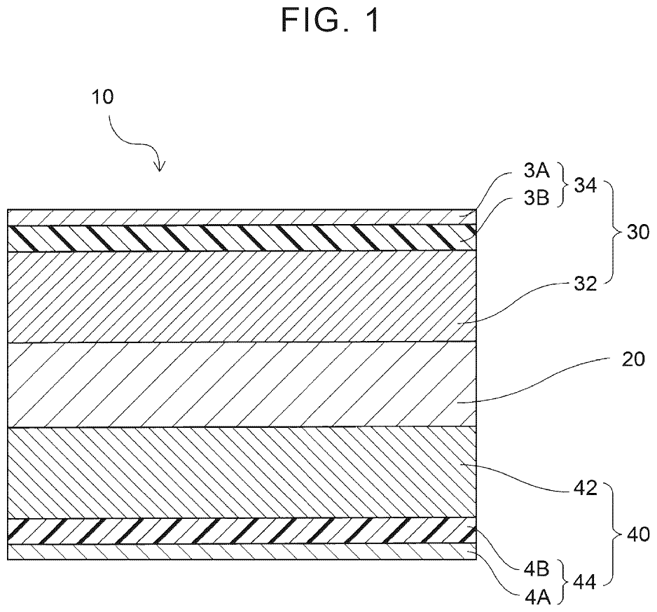

FIG. 1 is a partial sectional view illustrating an example of the layer structure of the solid-state battery of the present disclosure.

A solid-state battery 10 includes a solid electrolyte layer 20, an anode 30, and a cathode 40. The anode 30 includes an anode active material layer 32 and an anode current collector 34. The anode current collector 34 includes a metal layer 3A (an example of the substrate) and a resin layer 3B.

The cathode 40 includes a cathode active material layer 42 and a cathode current collector 44. The cathode current collector 44 includes a metal layer 4A (an example of the substrate) and a resin layer 4B.

The method for manufacturing a battery and the battery according to the present disclosure will be described in further detail below based on examples. The materials, procedures, and processing conditions described in the examples below may be modified as appropriate without departing from the spirit and scope of the present disclosure. Therefore, the method for manufacturing a battery and the battery according to the present disclosure should not be construed as restrictive based solely on the specific examples given below.

Unless otherwise specified, synthesis, treatment, and fabrication in the following description were performed at room temperature (25° C.±3° C.).

In the following description, the “resin current collector” will be referred to as “resin current collector foil.”

Vinyl resins α, β used in Examples 1 to 6 and Comparative Examples 1, 2 are the same. The compositions of the two resins are as follows.
Vinyl resin α: polyvinyl butyral: a calculated molecular weight of 108,000, approximately 31 mol % of hydroxyl groups, approximately 68 mol % of butyral groups, approximately 1 mol % of acetyl groups, and a functional group concentration of 2.8 mmol/g
Vinyl resin β: polyvinyl butyral: a calculated molecular weight of 32,000, approximately 19 mol % of hydroxyl groups, approximately 79 mol % of butyral groups, approximately 2 mol % of acetyl groups, and a functional group concentration of 1.5 mmol/g

### Example 1

### Preparation of Resin Current Collector Foil

First resin: 56 parts by mass of vinyl resin α that is insoluble in the solvent of the second slurry
Second resin: 24 parts by mass of vinyl resin β that is soluble in the solvent of the second slurry
Electrically conductive material: 20 parts by mass of a carbon material

The above materials were added to 2-ethylhexanol and mixed by stirring to prepare a first slurry. The first slurry was applied to one surface of a nickel (Ni) foil using a blade coating method. The coated foil was placed on a hot plate at 80° C. for 30 minutes, and then on a hot plate at 170° C. for another 30 minutes, thereby obtaining a resin current collector foil.

### Preparation of Anode

Anode active material (silicon (Si)): 49.3 parts by mass
Sulfide solid electrolyte (SE) (Li₂S—P₂S₅): 41.5 parts by mass
Vapor-grown carbon fiber (VGCF): 6.4 parts by mass
SBR: 2.8 parts by mass

The above materials were added to butyl butyrate and mixed by stirring using an ultrasonic disperser to prepare a second slurry. The second slurry was applied to the resin current collector foil using a blade coating method. The coated foil was placed on a hot plate at 50° C. for 30 minutes, and then on a hot plate at 170° C. for another 30 minutes to form an anode active material layer, thereby obtaining an anode.

### Example 2

An anode was obtained in the same manner as in Example 1, except that the parts by mass of the first resin and the second resin constituting the first slurry were changed as follows.
First resin: 48 parts by mass of vinyl resin α that is insoluble in the solvent of the second slurry
Second resin: 32 parts by mass of vinyl resin β that is soluble in the solvent of the second slurry

### Example 3

An anode was obtained in the same manner as in Example 1, except that the parts by mass of the first resin and the second resin constituting the first slurry were changed as follows.
First resin: 40 parts by mass of vinyl resin α that is insoluble in the solvent of the second slurry
Second resin: 40 parts by mass of vinyl resin β that is soluble in the solvent of the second slurry

### Example 4

An anode was obtained in the same manner as in Example 1, except that the parts by mass of the first resin and the second resin constituting the first slurry were changed as follows.
First resin: 32 parts by mass of vinyl resin α that is insoluble in the solvent of the second slurry
Second resin: 48 parts by mass of vinyl resin β that is soluble in the solvent of the second slurry

### Example 5

An anode was obtained in the same manner as in Example 1, except that the parts by mass of the first resin and the second resin constituting the first slurry were changed as follows.
First resin: 24 parts by mass of vinyl resin α that is insoluble in the solvent of the second slurry
Second resin: 56 parts by mass of vinyl resin β that is soluble in the solvent of the second slurry

### Example 6

An anode was obtained in the same manner as in Example 1, except that the parts by mass of the first resin and the second resin constituting the first slurry were changed as follows.
First resin: 16 parts by mass of vinyl resin α that is insoluble in the solvent of the second slurry
Second resin: 64 parts by mass of vinyl resin β that is soluble in the solvent of the second slurry

### Comparative Example 1

An anode was obtained in the same manner as in Example 1, except that the parts by mass of the first resin and the second resin constituting the first slurry were changed as follows.
First resin: 0 parts by mass of vinyl resin α that is insoluble in the solvent of the second slurry
Second resin: 80 parts by mass of vinyl resin β that is soluble in the solvent of the second slurry

### Comparative Example 2

An anode was obtained in the same manner as in Example 1, except that the parts by mass of the first resin and the second resin constituting the first slurry were changed as follows.
First resin: 80 parts by mass of vinyl resin α that is insoluble in the solvent of the second slurry
Second resin: 0 parts by mass of vinyl resin β that is soluble in the solvent of the second slurry

### Performance Evaluation

### Check for Interlayer Delamination

The anode was tilted and flipped over to check whether interlayer delamination would occur due to gravity. The results are shown in Table 1.
G: No delamination occurred.
NG: Interlayer delamination occurred between the resin current collector foil and the anode active material layer.

### Measurement of Peel Strength

The anode (the resin current collector foil and the anode active material layer) was punched into a circular shape with a diameter of 14.5 mm, and a peeling test was conducted according to the following procedure.

The nickel (Ni) foil side of the anode was fixed to the stage of a tensile tester (STB-1225S, manufactured by A&D Company, Limited) using a double-sided tape.

A circular double-sided tape with a diameter of 11.28 mm (an area of 1 cm²) was attached to the side of the anode active material layer of the anode under a pressing load of 50 N. The opposite surface of the double-sided tape was attached to the fixture of the tensile tester. The fixture of the tensile tester was pulled upward, and the load (kPa) at which the anode active material layer peeled off from the resin current collector foil was measured. The peel strength was calculated by dividing the measured load by the tape area (1 cm²). The measurement results are shown in Table 1.

For the anode of Comparative Example 2, interlayer delamination occurred under gravity alone, and thus measurement of the peel strength was not possible.

TABLE 1

| | Resin Composition | | |
|---|---|---|---|
| | in First Slurry | | |
| | First Resin:Second | Interlayer | |
| | Resin (Insoluble | Delamination | Peel |
| | Resin:Soluble Resin) | Classification | Strength |
| | Mass Ratio | Rating | kPa/cm² |
| Example 1 | 70:30 | G | 63 |
| Example 2 | 60:40 | G | 60 |
| Example 3 | 50:50 | G | 58 |
| Example 4 | 40:60 | G | 65 |
| Example 5 | 30:70 | G | 83 |
| Example 6 | 20:80 | G | 115 |
| Comparative | 0:100 | G | 24 |
| Example 1 | | | |
| Comparative | 100:0 | NG | Not |
| Example 2 | | | Measurable |

From the presence or absence of interlayer delamination and the values of peel strength shown in Table 1, it can be seen that the adhesion between the resin layer and the electrode active material layer is improved when the slurry for forming the resin layer of the resin current collector foil contains both the first resin and the second resin.

### Raman Spectroscopy

Cross-sectional samples of the anodes of Example 6 and Comparative Example 2 were prepared, and each cross-sectional sample was subjected to Raman spectroscopy. The analysis was performed using the Raman spectrometer XploRA PLUS (manufactured by HORIBA, Ltd.) over the measurement wavenumber range of 200 cm-1 to 4000 cm⁻¹ at a laser wavelength of 532 nm.

The peak near 500 cm⁻¹ was assigned to silicon (Si) (the anode active material), the peak near 1000 cm⁻¹ was assigned to SBR (the binder resin of the anode), and the peak near 2700 cm⁻¹ was assigned to carbon (C).

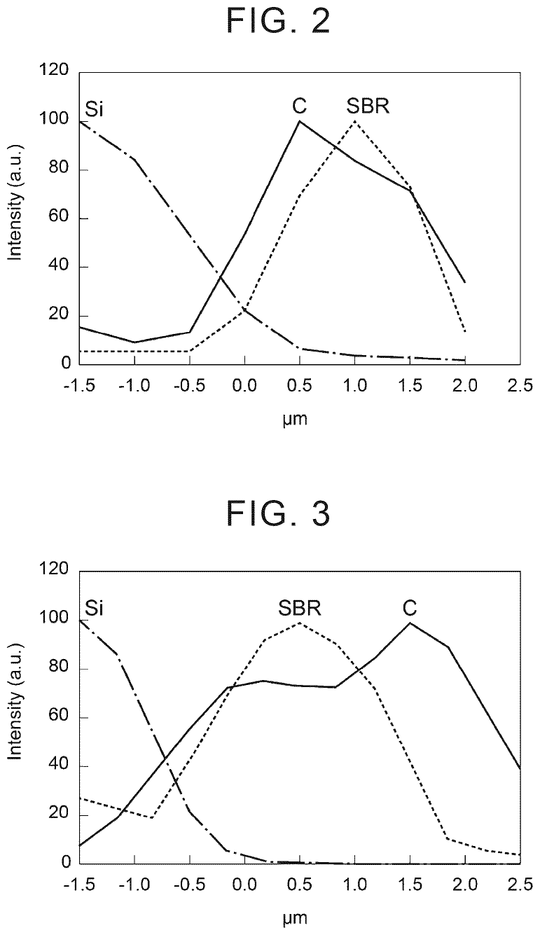

FIGS. 2 and 3 show component profiles in the thickness direction of the anode cross-section, based on Raman spectroscopy. FIG. 2 shows the component profile of Example 6, and FIG. 3 shows the component profile of Comparative Example 2. The horizontal axis represents the relative distance (μm) in the thickness direction of the anode cross-section. The left side of the horizontal axis indicates the anode active material layer, and the right side thereof indicates the nickel (Ni) foil.

In the component profile of Example 6, the peak top of C was located closer to the anode active material layer than the peak top of SBR, and the peaks of C and SBR substantially overlapped.

In the component profile of Comparative Example 2, the peak top of SBR was located closer to the anode active material layer than the peak top of C, and there was little overlap between the peaks of C and SBR.

These results indicate that, in Example 6, a region in which the electrically conductive material of the resin layer and the binder resin of the anode active material layer are intermixed is present at the interface between the resin layer of the resin current collector foil and the anode active material layer.

What is claimed is:

1. A method for manufacturing a battery, the method comprising:
a step of obtaining a resin current collector by applying a first slurry containing a first resin and a second resin to one or both surfaces of a substrate and solidifying the first slurry to form a resin layer; and
a step of obtaining an electrode by applying a second slurry containing an electrode active material and a solvent to the resin layer of the resin current collector and solidifying the second slurry to form an electrode active material layer, wherein:
the first resin is a resin that is not soluble in the solvent of the second slurry; and
the second resin is a resin that is soluble in the solvent of the second slurry.

2. The method according to claim 1, wherein a mass ratio of the first resin to a total of the first resin and the second resin contained in the first slurry is from 10 mass % to 85 mass %.

3. A battery comprising an electrode including a resin current collector that includes a substrate and a resin layer disposed on one or both surfaces of the substrate, and an electrode active material layer that is in contact with the resin layer of the resin current collector, wherein:
the resin layer of the resin current collector contains a first resin and a second resin;
the first resin is a resin that does not exhibit solubility in a solvent species of a residual solvent in the electrode active material layer; and
the second resin is a resin that exhibits solubility in the solvent species of the residual solvent in the electrode active material layer.

4. A battery comprising an electrode including a resin current collector that includes a substrate and a resin layer disposed on one or both surfaces of the substrate, and an electrode active material layer that is in contact with the resin layer of the resin current collector, wherein:
the resin layer of the resin current collector contains an electrically conductive material;
the electrode active material layer contains a binder resin; and
a region in which the electrically conductive material of the resin layer and the binder resin of the electrode active material layer are intermixed is present at an interface between the resin layer and the electrode active material layer.

5. The battery according to claim 3, wherein the battery is a solid-state battery.

6. The battery according to claim 4, wherein the battery is a solid-state battery.
